(19) United States
(12) Patent Application Publication
(10) Pub. No.: US 2002/0159708 A1
(43) Pub. Date: Oct. 31, 2002

(54) Optical fiber connector mounting

(76) Inventor: Wayne A. Nelson, Stowe, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/843,635

(22) Filed: Apr. 26, 2001

(51) Int. Cl. G02B 6/36

(52) U.S. Cl. 385/53

(57) ABSTRACT

An adapter molded of plastic, for mounting a fiber optic cable connector on an opening in a panel, the adapter having, when installed on the panel, a surface disposed at an angle of approximately 30° to the panel, said surface having at least one aperture for receiving an optical fiber connector assembly, and a plurality of snap feet depending in such locations and so dimensioned as to be usable to secure the adapter in a suitably sized and configured aperture in a panel.

### FIELD OF THE INVENTION

This invention relates to the field of optical fiber connections and, more particularly, to a mounting member, or adapter, for mounting optical fiber connectors on equipment panels.

### BACKGROUND OF THE INVENTION

In the past two to three decades, optical fiber has become a medium of choice for the wide-band transmission of information. Optical fibers are used to convey both analog signals and digital signals. They are used with increasing frequency within computer and communications networks. In those applications, in particular, fiber connectors are often arranged in arrays on exterior panels of switching and signal-processing equipment. Such connectors are provided to allow appropriately terminated optical fibers to be connected to circuit elements within the equipment to form desired physical signal transmission links. (Those circuit elements may be electrical, optical or a combination of those two types.) There exist a variety of commercially available optical fiber connector assemblies suitable for such applications. These assemblies typically include a first connector member, or housing, which mounts on a flat surface such as an equipment panel (or bracket on a circuit board) and a second, mating connector member that is used to terminate an optical fiber. For example, such connector assemblies include the SC connector assemblies of AMP, Incorporated or Fotec.

As illustrated in FIG. 1, the first member 8 of a typical prior art connector assembly 10 is designed for mounting against or on or in a flat panel 12 and the mating second member 16 inserts in the first member in such an orientation as to feed the optical fiber 18 into the connector assembly normal to panel 12. To secure the first member 8 on or in panel 12, member 8 may be provided with a flat surface or flanges 12 which may be fastened to the panel, or it may be provided with spring-type retaining fins (wings) that are restrained flat against the body of the first member when it is inserted into a hole in the panel and then spring outward, bearing against the inside surface of the panel and preventing withdrawal of the first member. Since the panel 12 typically is disposed vertically on a chassis mounted in an equipment rack, the fiber cables usually must be bent 90° to run horizontally or vertically to other equipment or conduits carrying the cables to other rooms, or outside a building. Sometimes, the panel 14 is fixed to a circuit board (not shown) on which are mounted components to interface to the optical fibers 18. To protect the fibers at their most vulnerable portions, where they are strained by bending, and where physical disturbance can adversely impact coupling in the connector assembly, they may be sheltered in a channel formed by a closed or partly open conduit. The conduit must be sized to allow for the minimum bend radius (typically about 1.5 inches) that the fibers can tolerate.

In the network industry, dozens of such connector assemblies may be arranged in close space on a panel, and multiple panels may be stacked or arranged side-by-side in close proximity. The resulting density of fiber optic cables gives rise to a need for orderly routing of those fiber optic cables. Without effective fiber management, the system of fiber cables quickly will become a tangled complex mess, resulting in confusion of maintenance and installation personnel and greater than necessary network down time, which is costly.

Additionally, it is desired to minimize the size/dimensions of space consumed in allowance for the bending radius of the glass fibers. This dimension may be “enlarged” by virtue of the actual termination of the fiber being above the plane of the mounting surface (panel).

To address these issues, as shown in FIG. 2, there is sometimes used an adapter 20 which is secured to the panel 14 and which provides a surface 22 tilted substantially (e.g., more or less 30°), on which the first connector member 8 is mounted. This adapter, a bottom view of which is shown in FIG. 3, has been machined from a single piece of aluminum stock. It is secured to the panel 14 with four screws which thread into holes 24 tapped into the bottom of the adapter. Thus, the adapter itself, by virtue of expensive machining, costs around $60 in year 2000 dollars and involves substantial labor cost to install.

### SUMMARY OF THE INVENTION

A low-cost alternative to the machined adapter is shown. This alternative is, in one aspect, a molded plastic adapter piece which mounts to a panel and provides an angled surface having one or more apertures therein for receiving a fiber connector assembly. A first member of a fiber connector assembly may be mounted to the angled surface, over or through the aperture, providing a mounting position that results in less stress on the fiber and a smaller conduit/channel requirement by virtue of the fiber having to experience fewer degrees of bending.

The molded plastic mounting adapter may include a number of integral plastic snap feet, with or without one or more locating posts, allowing the adapter to be mounted to a panel simply by being pressed against an appropriately-sized and shaped aperture therein.

Optionally, a place may be provided in a surface of the adapter other than that on which the fiber connector assembly is mounted, in an associated position, for affixing a label to identify the fiber or its connection in some manner. This label mounting place may have side walls or channels to facilitate a label being slid into position and retained there.

These and other features and advantages of the invention will become evident from the detailed description which follows and from the accompanying drawings.

### BRIEF DESCRIPTION OF THE DRAWINGS

In the drawings, like elements in the several figures are denoted by like reference designations unless otherwise noted. The drawings should not be assumed to be to scale.

In the drawings:

FIG. 1 is an isometric view of a prior art SC optical fiber connector, with fiber, installed in a panel;

FIG. 2 is a top isometric view of a prior art connector adapter installed in a panel, without a connector installed;

FIG. 3 is a bottom isometric view of the adapter of FIG. 2, though not installed in a panel;

FIG. 4 is a top isometric view of an adapter according to the invention;

FIG. 5 is a bottom isometric view of the adapter of FIG. 4;

FIG. 6 is a bottom isometric view of the adapter of FIGS. 4 and 5, installed in a panel (cutaway); and

FIG. 7 is an isometric, diagrammatic view of a filter assembly, or shelf, showing a number of adapters as described herein, in use.

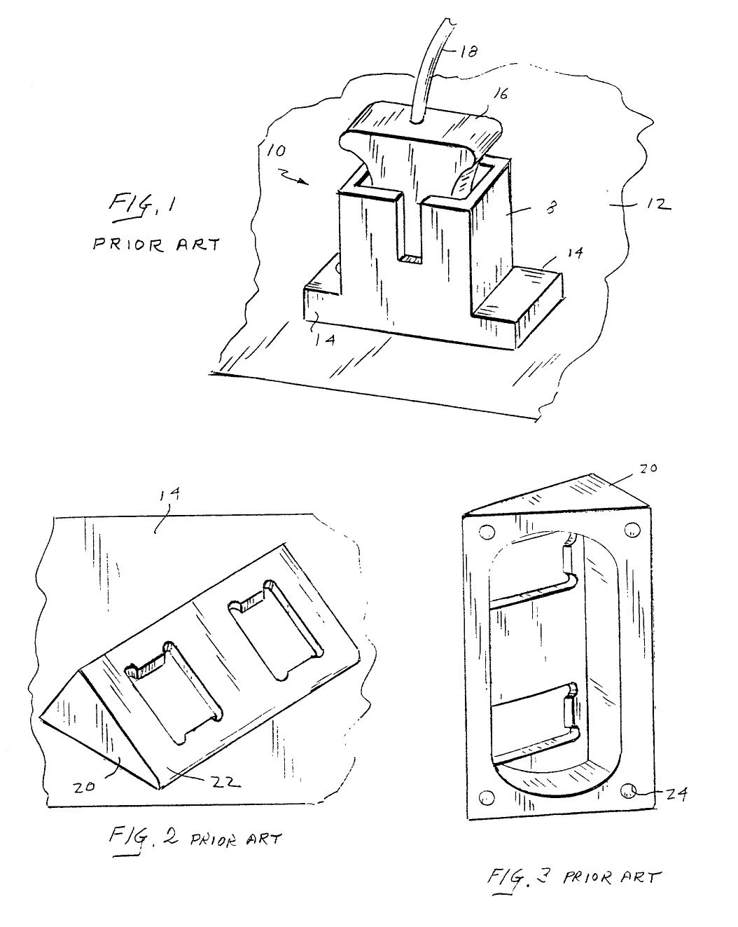

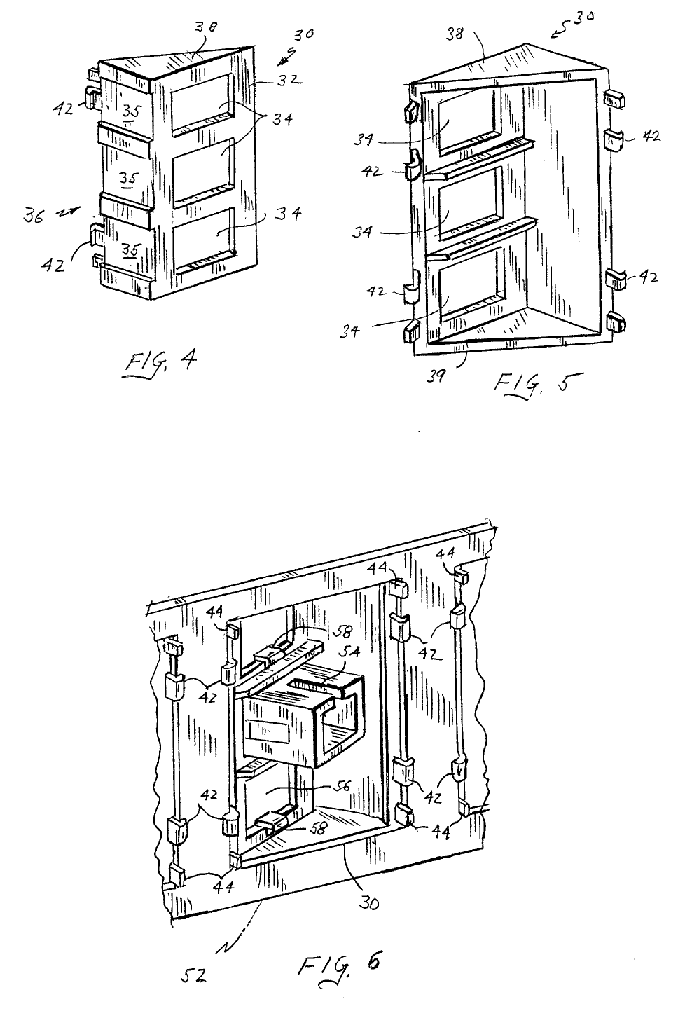

### DETAILED DESCRIPTION

Turning to FIGS. 4-6, there is shown a molded plastic adapter 30 according to an illustrative embodiment of the invention. The adapter 30 has a first surface 32 containing apertures 34 for receiving connector assemblies (three such apertures being illustrated but it being understood that from one to several apertures may be provided), second surface 36 and a pair of triangular end panels 38, 39. Bottom edges of the surfaces 32, 36 and end panels 38, 39 form a rectangular perimeter which may be positioned against a mounting surface. A plurality of retaining snaps 42 depend from the bottom of the adapter, preferably from opposing edges. When the adapter is placed over a correspondingly sized opening in a panel, the snaps slide against the edge of the opening and snap into position to retain the adapter in position. Optionally, a plurality of positioning posts 44 also may depend from the bottom edge of the adapter. The posts 44 may, for example, be located so as to fit into the corners of the opening in the panel and prevent translation of the adapter when it is installed.

On second surface 36 (which is disposed at an angle of about 90 degrees to the first surface, opposite each of the apertures 34, there may be provided a place 35 for affixation or insertion of a label to identify the fiber optic cable or connection associated with the connector assembly mounted in the aperture 34.

FIG. 6 shows a bottom perspective view of portion of a panel 52 with the adapter 30 mounted therein and a single connector assembly 54 installed in the adapter. The adapter 30 is shown as having three apertures for connector assemblies but with only one connector assembly installed in the middle position. The other two apertures are covered by blank caps or plugs 56 having retaining snaps 58 to keep them in position.

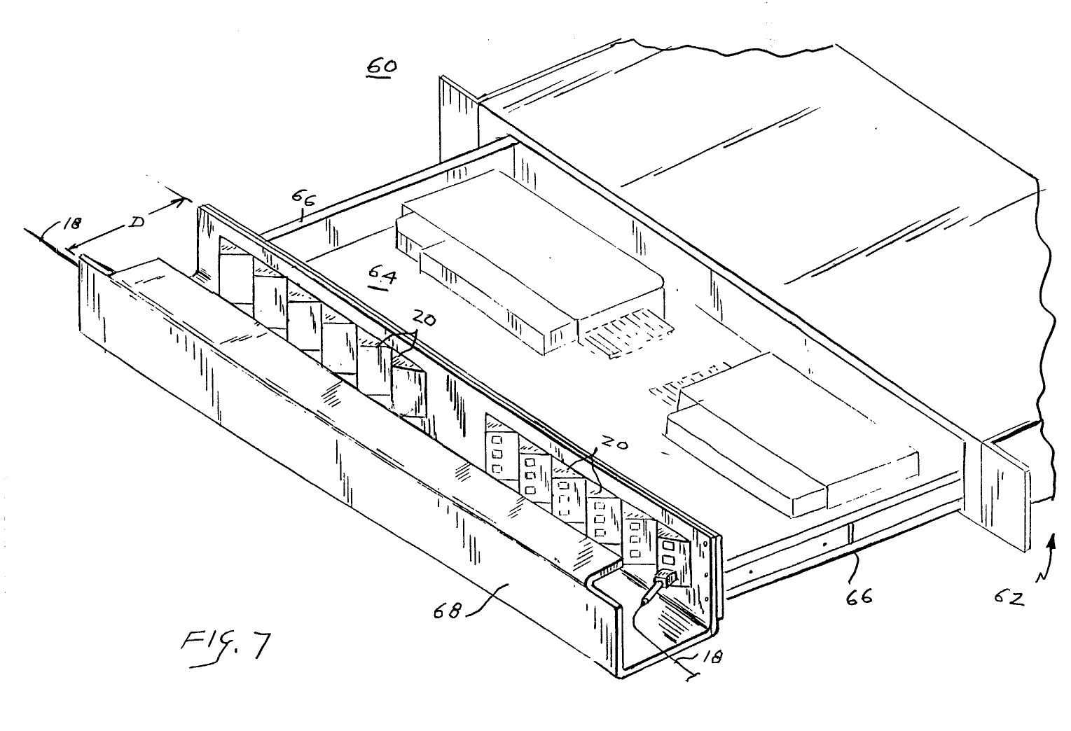

A typical use for an adapter according to the present invention is illustrated in FIG. 7. This figure shows a filter module 60 having a housing 62, into which slides a circuit board 64 with appropriate electrical and/or optical signal processing elements, supported on side rails 66. A U-shaped channel 68, also supported on the side rails 66, provides a panel onto which are mounted several adapters 20 according to the invention. A first set of the adapters is oriented so that the fiber optic cables exit to the left and a second set of the adapters is oriented so that the fiber optic cables exit to the right. Note that one advantage of the use of the adapters is that the dimension D of the channel width can be less with the adapters than without them.

Having thus described the invention and various illustrative embodiments of the invention, some of its advantages and optional features, it will be apparent that such embodiments are presented by way of example only and not by way of limitation. Those persons skilled in the art will readily devise alterations and improvements on these embodiments, as well as additional embodiments, without departing from the spirit and scope of the invention. It is impossible to enumerate all of the variations that will quite quickly occur to those in the art. Accordingly, the invention is limited only as defined in the following claims and equivalents thereto.

What is claimed is:

1. An adapter molded of plastic, for mounting a fiber optic cable connector on an opening in a panel, the adapter having, when installed on the panel, a first surface disposed at an angle of approximately 30° to the panel, said first surface having at least one aperture for receiving an optical fiber connector assembly, and a plurality of snap feet depending in such locations and so dimensioned as to be usable to secure the adapter in a suitably sized and configured aperture in a panel.

2. The adapter of claim 1 further including a second surface, disposed at an angle of about 90° to the first surface, the second surface having, for each fiber connector assembly which may be mounted to the first surface, and areas for affixing a label to identify the fiber or its connection.

3. The adapter of claim 2 wherein the areas have channels to facilitate a label being slid into position and retained there.
